(19) United States
(12) Patent Application Publication
(10) Pub. No.: US 2019/0208843 A1
(43) Pub. Date: Jul. 11, 2019

(54) MASK, AND METHOD FOR DETECTING ADSORPTION CAPACITY THEREOF

(71) Applicant: BOE TECHNOLOGY GROUP CO., LTD., Beijing (CN)

(72) Inventor: Lin ZHU, Beijing (CN)

(21) Appl. No.: 16/330,911

(22) PCT Filed: May 15, 2018
(86) PCT No.: PCT/CN2018/086874

§ 371 Date: Mar. 6, 2019

(30) Foreign Application Priority Data
Jun. 19, 2017 (CN) 201710465175.3

(51) Int. Cl. A41D 13/11; G01N 21/55; G01N 21/59

(52) U.S. Cl. CPC A41D 13/11; G01N 21/59; G01N 21/55

(57) ABSTRACT

Embodiments of the present disclosure provides a mask and a method for detecting adsorption capacity thereof. The mask includes a mask body, the mask body includes a filtering layer, the mask further comprises: a light emitter emitting light toward the filtering layer, a photosensitive sensor being configured for sensing intensity of light emitted by the light emitter after being transmitted or reflected by the filtering layer, and outputting a corresponding electrical signal.

The present application claims priority of Chinese Patent Application No. 201710465175.3 filed on Jun. 19, 2017, the disclosure of which is incorporated herein by reference in its entirety as part of the present application.

### TECHNICAL FIELD

Embodiments of the present disclosure relate to a mask and a method for detecting adsorption capacity thereof.

### BACKGROUND

At present, smog has become a severe weather phenomenon in cities, and smog is a result of interaction between specific climatic conditions and human activities; economic and social activities of high density population may inevitably discharge large amount of fine particles; once emission has exceeded atmospheric circulation capacity and carrying capacity, concentration of the fine particles may continue to accumulate, causing the smog phenomenon. In the smoggy weather, air pressure is reduced, inhalable particles in the air are suddenly increased, air fluidity is poor, and speed of spreading harmful bacteria and viruses to surrounding region is slow, resulting in high virus concentration in the air, and high risk of transmitting disease, so that people often wear anti-smog masks when they go out. The anti-smog masks use air filtering material and technology, and an anti-moisture layer of an outermost layer thereof may effectively block large particles in the smoggy air, and dust-free granular activated carbon is added in middle of a filtering sheet of the mask, which not only can deeply purify the dust, but also can adsorb toxic gas, further improving safety of the mask.

However, as time of using the mask increases, adsorption capacity of the mask on the particles in the smog and hazardous substances such as the dust in the air gradually decreases; since a change in the adsorption capacity of the mask is not known, it is impossible to determine whether the mask can be continuously used and when a reasonable replacement may be made, and thus, how to detect the change in the adsorption capacity of the mask, so as to make a replacement of the mask in time, becomes a problem to be solved.

### SUMMARY

An embodiment of the present application provides a mask and a method for detecting adsorption capacity thereof, for detecting the change in the adsorption capacity of the mask so as to prompt a user to replace the mask in time.

An embodiment of the present application provides a mask, comprising a mask body, the mask body including a filtering layer, wherein, the mask further comprises: a light emitter disposed on a side of the filtering layer, the light emitter emitting light toward the filtering layer; a photosensitive sensor disposed on a side of the filtering layer or on an other side opposite to the side of the filtering layer, the photosensitive sensor being configured for sensing intensity of light emitted by the light emitter after being transmitted or reflected by the filtering layer, and outputting a corresponding electrical signal; and a processing module, the processing module being connected with the light emitter and the photosensitive sensor, configured for driving the light emitter to emit light, and outputting a prompt of remaining adsorption capacity according to the electrical signal transmitted by the photosensitive sensor.

For example, the light emitter includes one light emitting unit, or a light emitting array formed by at least two light emitting units; and the photosensitive sensor includes one sub-photosensitive sensor, or a photosensitive array formed by at least two photosensitive sensors.

For example, the light emitter and the photosensitive sensor are located on a same side of the filtering layer, the light emitter and the photosensitive sensor forms an array structure; a transflective film is disposed between the filtering layer and the array structure formed by the light emitter and the photosensitive sensor.

For example, the processing module includes: a display unit and a converting circuit connected between the photosensitive sensor and the display unit; the converting circuit is configured for converting the electrical signal transmitted by the photosensitive sensor into a driving signal of the display unit, the display unit is configured for outputting a prompting signal according to the driving signal, the prompting signal being in one-to-one correspondence with the remaining adsorption capacity of the filtering layer.

For example, the converting circuit includes: an operational amplifier, two input terminals of the operational amplifier being connected with two terminals of the photosensitive sensor, and an output terminal of the operational amplifier being connected with the display unit; the operational amplifier being configured for amplifying the electrical signal to the driving signal.

For example, the converting circuit further includes: a voltage modulating circuit, the voltage modulating circuit being connected in series between an output terminal of the operational amplifier and the display unit; the voltage modulating circuit being configured for adjusting a voltage of the driving signal to satisfy a withstand voltage value of the display unit.

For example, the processing module includes: a processing unit and a wireless communication unit, the processing unit being configured for generating a remaining adsorption capacity parameter of the filtering layer according to the electrical signal, wherein the electrical signal is in one-to-one correspondence with the remaining adsorption capacity parameter of the filtering layer; the wireless communication unit being configured for outputting a remaining adsorption capacity parameter of the filtering layer to a user device in data connection with the wireless communication unit.

For example, the mask further comprises: an indicator light disposed on an outer side of the mask; the processing module being configured for receiving an instruction for turning on the indicator light output by a user device in data connection with the processing module, and turning on the indicator light according to the instruction; or the processing module being configured for receiving air quality information output by a user device in data connection with the processing module, and controlling turning on the indicator light according to the air quality information.

For example, the sub-photosensitive sensor includes a micro-mirror, a photosensitive material; the processing module includes a photonic crystal member, the photonic crystal member including a first electrode, a second electrode, and a photonic crystal disposed between the first electrode and the second electrode; the first electrode being connected with one terminal of the photosensitive material, and the second electrode being connected with an other terminal of the photosensitive material; the micro-mirror being configured for focusing light emitted by the light emitter after being transmitted or reflected by the filtering layer on the photosensitive material, and the photosensitive material being configured for generating the electrical signal according to intensity of the focused light, the photonic crystal being configured for color displaying according to a magnitude of the electrical signal, and the remaining adsorption capacity of the filtering layer being in one-to-one correspondence with the displayed color.

An embodiment of the present application provides a method for detecting absorption capacity of a mask, for controlling the mask as mentioned above, the method comprising: emitting light toward the filtering layer by the light emitter; sensing intensity of light emitted by the light emitter after being transmitted or reflected by the filtering layer and outputting a corresponding electrical signal, by the photosensitive sensor; driving the light emitter to emit light and outputting a prompt of remaining adsorption capacity according to the electrical signal transmitted by the photosensitive sensor, by the processing module.

At least embodiment of the present disclosure provides the mask which comprises the mask body, the mask body includes a filtering layer, a light emitter disposed on a side of the filtering layer, the light emitter emitting light toward the filtering layer; a photosensitive sensor disposed on a side of the filtering layer or on an other side opposite to the side of the filtering layer, the photosensitive sensor being configured for sensing intensity of light emitted by the light emitter after being transmitted or reflected by the filtering layer, and outputting a corresponding electrical signal; and a processing module, the processing module being connected with the light emitter and the photosensitive sensor, configured for driving the light emitter to emit light, and outputting a prompt of remaining adsorption capacity according to the electrical signal transmitted by the photosensitive sensor, so that a change in the adsorption capacity of the mask at this time may be detected, thereby prompting a user to replace the mask in time.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a structural schematic diagram of an anti-smog mask;

FIG. 2 is an internal structural schematic diagram I of a mask according to an embodiment of the present disclosure;

FIG. 3 is an internal structural schematic diagram II of a mask according to an embodiment of the present disclosure;

FIG. 4 is an internal structural schematic diagram III of a mask according to an embodiment of the present disclosure;

FIG. 5 is a schematic diagram I of a working mode of an internal structure of a mask according to an embodiment of the present disclosure;

FIG. 6 is a schematic diagram of a light emitting unit and a photosensitive array in a mask according to an embodiment of the present disclosure;

FIG. 7 is a schematic diagram of a light emitting array and a photosensitive sensor in a mask according to an embodiment of the present disclosure;

FIG. 8 is a schematic diagram of detecting adsorption capacity of a mask by a light emitter and a photosensitive sensor in a mask according to an embodiment of the present disclosure;

FIG. 9 is a structural schematic diagram of an array formed by a light emitter and a photosensitive sensor module according to an embodiment of the present disclosure;

FIG. 10 is an internal structural schematic diagram IV of a mask according to an embodiment of the present disclosure;

FIG. 11 is a schematic diagram of a whole device packaged by a light emitter, a photosensitive sensor and a transflective film in a mask according to an embodiment of the present disclosure;

FIG. 12 is an internal structural schematic diagram V of a mask according to an embodiment of the present disclosure;

FIG. 13 is an internal structural schematic diagram VI of a mask according to an embodiment of the present disclosure;

FIG. 14 is an internal structural schematic diagram VII of a mask according to an embodiment of the present disclosure;

FIG. 15 is an internal structural schematic diagram VIII of a mask according to an embodiment of the present disclosure;

FIG. 16 is an internal structural schematic diagram IX of a mask according to an embodiment of the present disclosure;

FIG. 17 is a schematic diagram II of a working mode of an internal structure of a mask according to an embodiment of the present disclosure; and

FIG. 18 is a flow chart of steps of a method for detecting adsorption capacity of a mask according to an embodiment of the present disclosure.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

It needs to be denoted that in embodiments of the present application, “of”, “corresponding” and “relevant” sometime may be used confusedly, and when the distinction thereof is not emphasized, the meanings thereof are the same.

An anti-smog mask, also known as a PM2.5 mask, refers to a mask that may effectively filter PM2.5 particles. PM2.5 refers to particles having an aerodynamic equivalent diameter less than or equal to 2.5 μm (micrometer) in ambient air, is also called fine particles, which may be directly inhaled into human body, and interfere with gas exchange in lungs, causing diseases such as asthma, bronchitis and cardiovascular diseases. Tightness of the mask determines capacity of filtering suspended particulate molecules. Invisible killers in the air, tiny particles such as smog, viruses, bacteria, dust mites and pollen may be effectively filtered. The mask is suitable for environments of poor air quality.

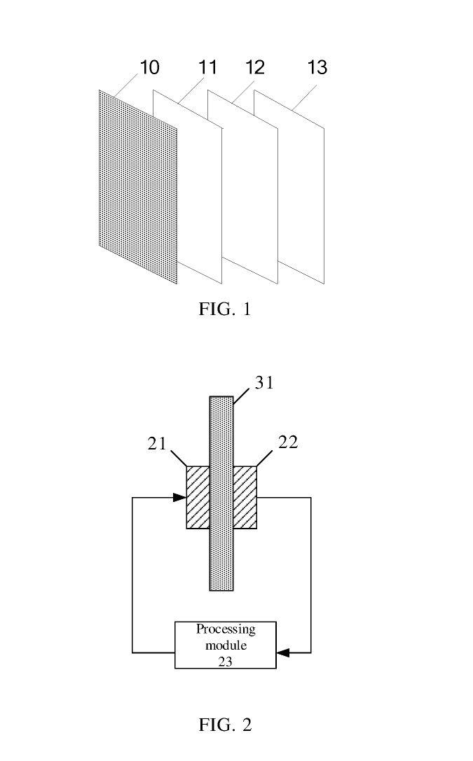

Referring to FIG. 1, a structure of an anti-smog mask is generally formed by an anti-moisture layer 10, an activated carbon layer 11, a filter net layer 12 and a super flexible fine fiber layer 13 from an outer side to an inner side of the mask, wherein the anti-moisture layer 10 is mainly used for blocking particles having a diameter greater than 10 μm in the air, the activated carbon layer 11 is used for blocking and adsorbing particles having a diameter from 2.5 μm to 10 μm in the air, and finally the filter net layer 12 is used for blocking particles having a diameter less than 2.5 μm, thereby filtering large particles in the air, the super flexible fine fiber layer 13 is located in a position of the mask close to mouth and nose of a person, uses antibacterial fabric, has a super antibacterial rate greater than 90%, and has high water absorption capacity and sweat absorption capacity.

As time of using a mask increases, capacity to absorb harmful substances such as particles in the smog and dust in the air gradually decreases. Since people do not know the change in adsorption capacity of the mask, it is impossible to determine whether the mask may be continuously used and when a reasonable replacement may be made, and thus, embodiments of the present disclosure provide a solution for detecting the change in the adsorption capacity of the mask so as to prompt a user to replace the mask in time.

An embodiment of the present disclosure provides a mask, the mask comprises a mask body, and the mask body includes a filtering layer, wherein the filtering layer is a layer in the mask which filters particles and determines adsorption capacity of the mask, and an embodiment of the present disclosure takes the filtering layer as a general term of the anti-moisture layer, the activated carbon layer and the filter net layer in the mask for description, and the mask further comprises:

A light emitter, disposed on a side of the filtering layer, the light emitter emitting light toward the filtering layer.

A photosensitive sensor, disposed on a side of the filtering layer where the light emitter is disposed or on a side opposite to the side of the filtering layer where the light emitter is disposed, the photosensitive sensor being used for sensing intensity of light emitted by the light emitter after being transmitted through the filtering layer or reflected by the filtering layer, and outputting a corresponding electrical signal.

A processing module, the processing module being connected with the light emitter and the photosensitive sensor, for driving the light emitter to emit light, and outputting a prompt of remaining adsorption capacity according to the electrical signal transmitted by the photosensitive sensor.

The light emitter emits light toward the filtering layer, the photosensitive sensor senses intensity of light emitted by the light emitter after being transmitted through the filtering layer or reflected by the filtering layer, and outputs a corresponding electrical signal, and the processing module drives the light emitter to emit light, and outputs a prompt of remaining adsorption capacity according to the electrical signal transmitted by the photosensitive sensor, so that change in the adsorption capacity of the mask at this time may be detected, thereby prompting a user to replace the mask in time.

For example, the light emitter and the photosensitive sensor on the mask may be located on a same side or different sides of the filtering layer. Referring to FIG. 2, the light emitter 21 and the photosensitive sensor 22 are located on different sides of the filtering layer 31, and the photosensitive sensor 22 is located between the filtering layer 31 and the super flexible fine fiber layer, and the light emitter 21 emits light toward the filtering layer 31.

It should be noted that, the adsorption capacity of the mask is determined according to amount of particles adsorbed by the filtering layer 31 in the mask; when a small amount of particles is adsorbed by the filtering layer 31, it indicates that the mask has strong adsorption capacity at this time, and is not necessary to be replaced; and when the amount of particles adsorbed by the filtering layer 31 of the mask gradually increases, it indicates that the adsorption capacity of the mask is continuously weakened, and the mask should be replaced till the adsorption capacity is weakened to a certain extent. Therefore, when the light emitter 21 emits light toward the filtering layer 31, as the amount of the adsorbed substance on the filtering layer 31 gradually increases, the intensity of the light transmitted through the filtering layer 31 gradually decreases, and the photosensitive sensor 22 disposed on the other side of the filtering layer 31 may sense intensity of the light emitted by the light emitter 21 after being transmitted by the filtering layer 31, and output a corresponding electrical signal, and the processing module 23 may output a prompt of remaining adsorption capacity of the filtering layer 31 according to the electrical signal transmitted by the photosensitive sensor 22. Wherein, the processing module 23 is connected with the light emitter 21 and the photosensitive sensor 22, and is also used for supplying power to the light emitter 21.

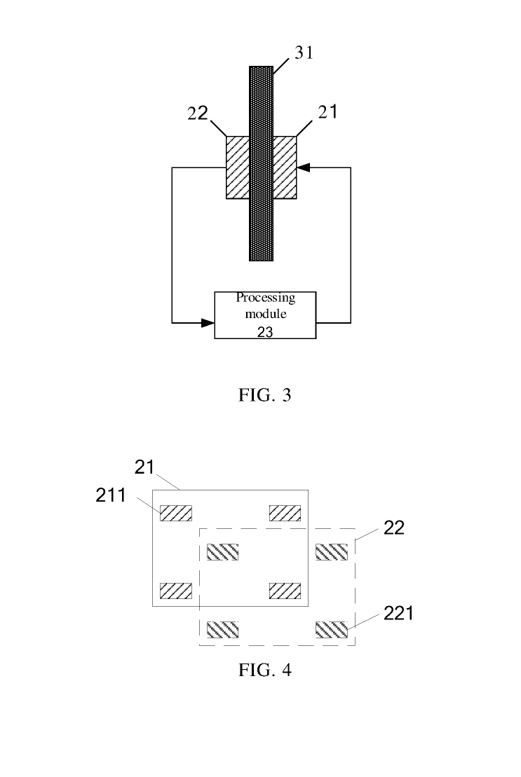

For example, referring to FIG. 3, positions of the light emitter 21 and the photosensitive sensor 22 may be interchanged according to actual conditions, that is, the light emitter 21 is located between the filtering layer 31 and the super flexible fine fiber layer, and principle of detecting the adsorption capacity of the mask is the same at this time, and since the light emitter 21 is placed on an inner side of the mask, influence of external light may be reduced to a certain extent, and the detection of the photosensitive sensor is more accurate.

For example, the light emitter includes one light emitting unit, or a light emitting array formed by at least two light emitting units, and the photosensitive sensor includes one sub-photosensitive sensor, or a photosensitive array formed by at least two sub-photosensitive sensors. For example, the light emitting unit is, for example, a light emitting diode (LED), an organic light emitting diode (OLED) or the like. For example, the sub-photosensitive sensor may be of various types such as a photosensitive diode, a photosensitive transistor or the like.

Referring to FIG. 4, the light emitter 21 is a light emitting array formed by at least two light emitting units 211, the photosensitive sensor 22 is a photosensitive array formed by at least two sub-photosensitive sensors 221, and the processing module outputs a remaining adsorption capacity parameter of the filtering layer according to an electrical signal matrix transmitted by the photosensitive array.

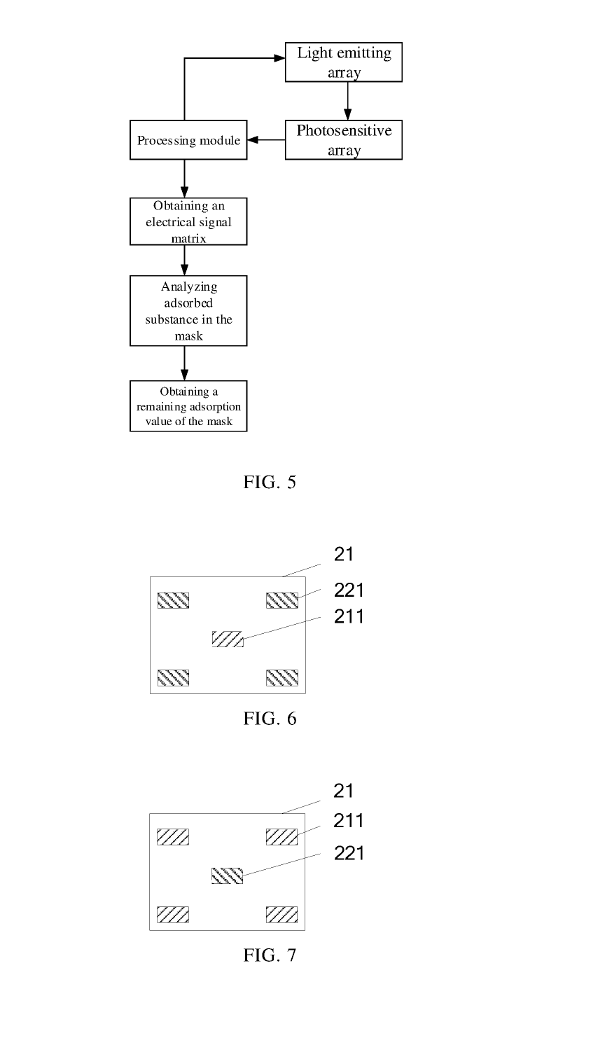

Referring to FIG. 5, there is a schematic diagram of a working mode when the light emitter is a light emitting array formed by at least two light emitting units and the photosensitive sensor is a photosensitive array formed by at least two sub-photosensitive sensors, and the processing module controls the light emitting array to emit light, and the photosensitive array receives intensity of light passing through the filtering layer and outputs a corresponding electrical signal, the processing module obtains an electrical signal matrix according to the electrical signal matrix transmitted by the photosensitive array and generates a remaining adsorption capacity parameter of the filtering layer, and analyzes conditions of adsorbed substance in the mask, and finally obtains a remaining adsorption value of the mask, and determines remaining use time of the mask, and reminds a user whether the mask should be replaced, wherein the electrical signal is in one-to-one correspondence with the remaining adsorption capacity parameter of the filtering layer.

Referring to FIG. 6, the light emitter 21 is one light emitting unit 211, and the photosensitive sensor 22 is a photosensitive array formed by at least two sub-photosensitive sensors 221, and at this time, the processing module controls the light emitting unit 211 to emit light, after the photosensitive array receives the light, the processing module may determine amount of absorbed substance in different directions of the filtering layer according to the electrical signals outputted by the photosensitive array, so as to make a judgment on the use of the entire mask, wherein, part of the sub-photosensitive sensors 221 in the photosensitive array may also be controlled for operation.

Referring to FIG. 7, the light emitter 21 is a light emitting array formed by at least two light emitting units 211, and the photosensitive sensor 22 is one sub-photosensitive sensor 221, and the processing module may control the light emitting units 211 in different positions in the light emitting array to emit light, and amount of adsorbed substance in different directions of the filtering layer may be obtained by collating the electrical signals outputted by the sub-photosensitive sensor 221, and remaining adsorption capacity of the mask may be obtained by analyzing comprehensively.

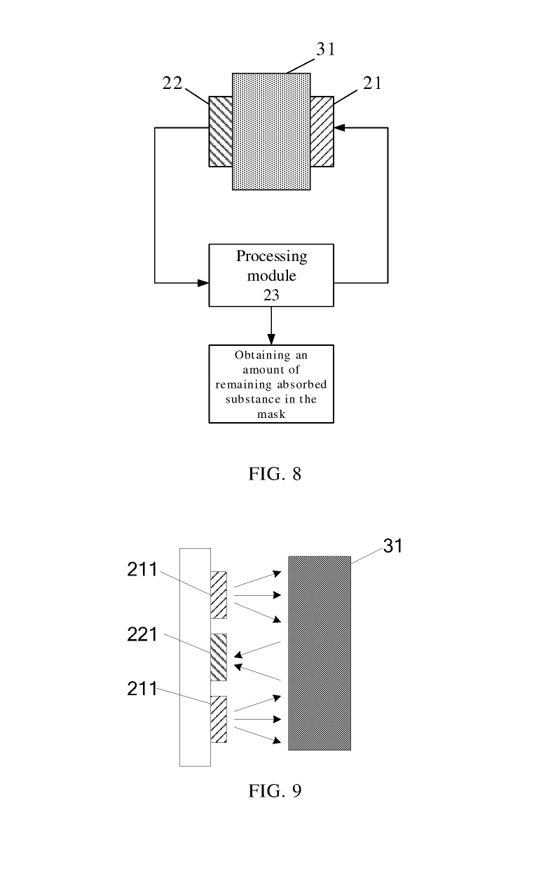

Referring to FIG. 8, there is a schematic diagram of detecting adsorption capacity of a mask by a light emitter 21 and a photosensitive sensor 22, the processing module 23 controls the light emitter to emit light toward the filtering layer 31, and the photosensitive sensor 22 senses intensity of the light emitted by the light emitter 21 after being transmitted through the filtering layer 31 or reflected by the filtering layer 31, and outputs a corresponding electrical signal to the processing module 23, and the processing module 23 generates a remaining adsorption capacity parameter of the filtering layer according to the electrical signal, and transmits to a user, so that the user may know use condition of the mask in time.

It should be noted that, in the above several implementation modes, the principle of detecting the adsorption capacity of the mask is unchanged, and similarly, the light emitter emits light toward the filtering layer, and the photosensitive sensor senses intensity of the light emitted by the light emitter after being transmitted through the filtering layer or reflected by the filtering layer, and outputs a corresponding electrical signal, and then the processing module outputs a prompt of remaining adsorption capacity of the filtering layer according to the electrical signal transmitted by the photosensitive sensor.

For example, referring to FIG. 9, the light emitter and the photosensitive sensor are located on a same side of the filtering layer 31, and at this time, the light emitter and the photosensitive sensor form an array structure, wherein the array includes at least one light emitting unit 211 and at least one sub-photosensitive sensor 221, and meanwhile the array may be located on any side of the filtering layer 31.

It should be noted that, when the light emitting unit emits light toward the filtering layer, since the amount of the adsorbed substance on the filtering layer gradually increases, intensity of the light transmitted through the filtering layer may gradually decrease, intensity of light reflected from the filtering layer to the sub-photosensitive sensor gradually increases, and the sub-photosensitive sensor outputs a corresponding electrical signal by sensing the intensity of the light, and the processing module may output a prompt of remaining adsorption capacity of the filtering layer according to the electrical signal transmitted by the photosensitive sensor.

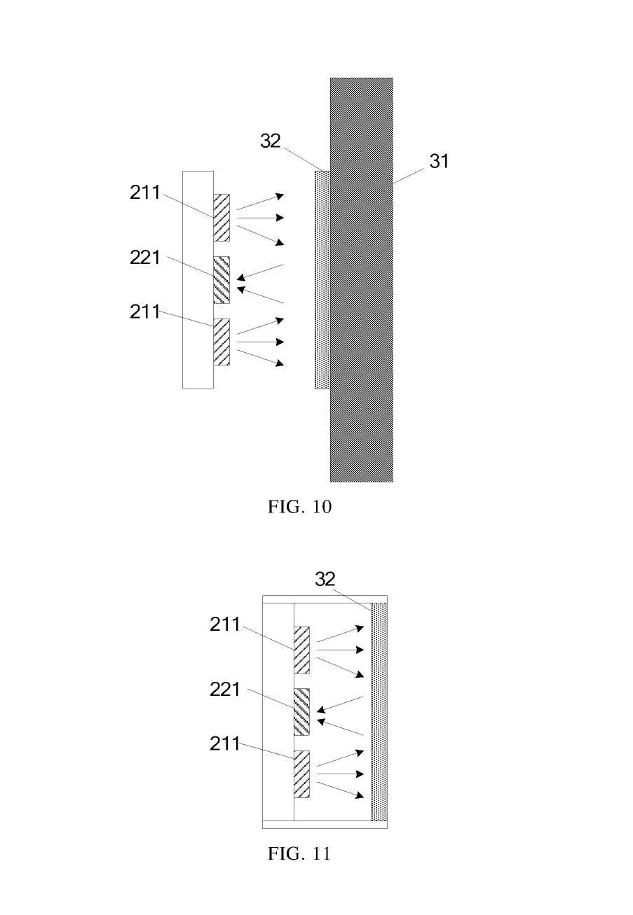

For example, referring to FIG. 10, a transflective film 32 is adhered on a side of the filtering layer 31, and the transflective film 32 is located between an array structure formed by the light emitter 21 and the photosensitive sensor 22 and the filtering layer 31. The transflective film 32 may better transmit the light emitted by the light emitting unit 211 to the sub-photosensitive sensor 221, so that the processing module 23 outputs a prompt of remaining adsorption capacity of the filtering layer according to the electrical signal transmitted by the sub-photosensitive sensor 221. The photosensitive sensor 22 may be a photoelectric diode.

For example, referring to FIG. 11, the light emitter 21, the photosensitive sensor 22 and the transflective film 32 are packaged as a whole member for detecting adsorption capacity of a mask, and the whole member may also be used in other scenarios of measuring the adsorption capacity; since it is an optical device, has simple principle and easy to operate, it may be used in more scenarios. The transflective film 32 used in a structure of the whole member may be a layered structure formed by depositing polymer in multilayer to transmit part of light and reflect part of the light, or a discontinuously evaporated metal film. Since a size of the member is about 5mm*5mm, the small size may not affect normal breathing; it may be installed at any position of the mask, and a best position is near nose and mouth.

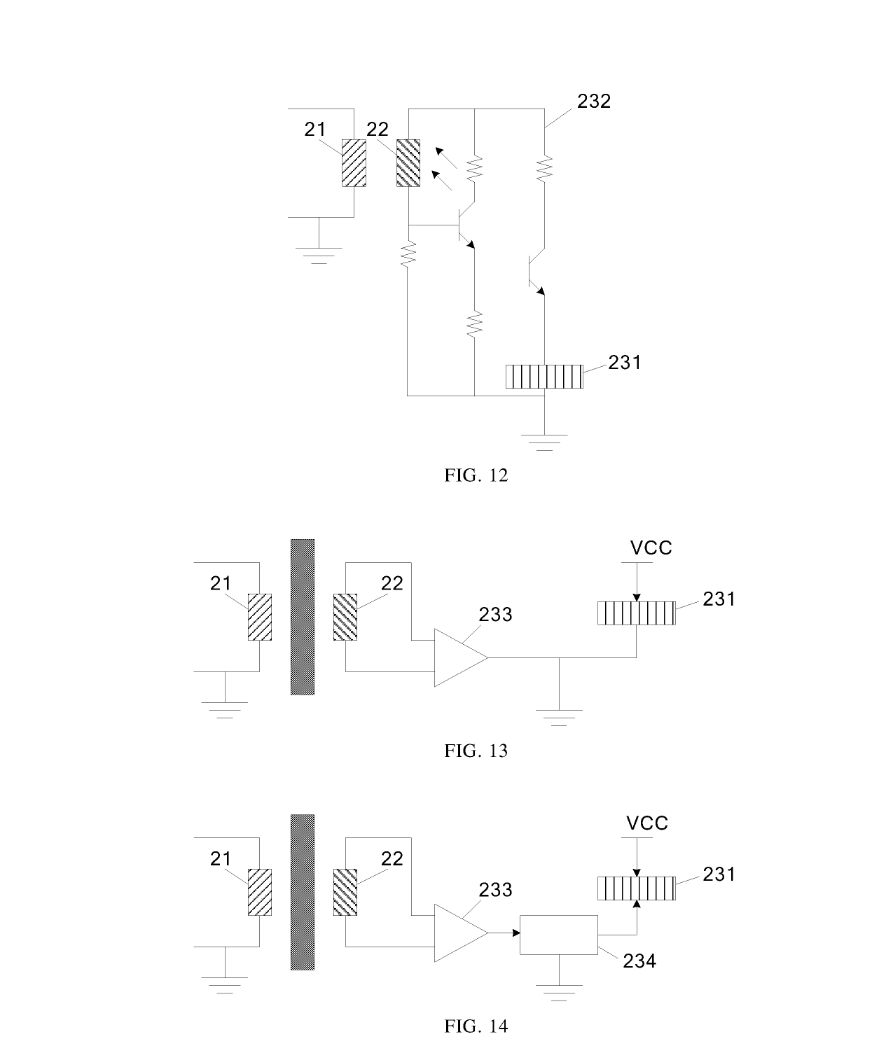

For example, referring to FIG. 12, the processing module includes a display unit 231, and a converting circuit 232 connected between the photosensitive sensor 22 and the display unit 231. For example, the display unit may be a device having a display function, such as an LCD display device, an OLED display device, an LED display device, a digital tube or the like, which may, for example, display an image or prompt information.

Therein, the converting circuit 232 is used for converting the electrical signal transmitted by the photosensitive sensor 22 into a driving signal of the display unit 231, wherein the display unit 231 is used for outputting a prompting signal according to the driving signal, and the prompting signal is in one-to-one correspondence with the remaining adsorption capacity of the filtering layer.

For example, the processing module applies a constant voltage on the light emitter 21 to check a voltage Vs of the photosensitive sensor 22, and then a voltage of an electrode of the display unit 231 may be obtained by adjusting the circuit, that is, V=VCC-Vs-1.4; because the photosensitive sensor 22 may generate different voltages Vs in different transmitting conditions, the voltage of the display unit 231 may be affected such that different prompting signals is output by the display unit 231, and the prompting signal may be that the display unit 231 performs color changing display according to the driving signal, for example, when the remaining adsorption capacity of the filtering layer is strong, the display unit 231 displays green, and when the remaining adsorption capacity of the filtering layer is weak, the display unit 231 displays red.

For example, referring to FIG. 13, the converting circuit 232 includes an operational amplifier 233, two input terminals of the operational amplifier 233 are connected with both terminals of the photosensitive sensor 22, an output terminal of the operational amplifier 233 is connected with the display unit 231, and the operational amplifier 233 is used for amplifying the electric signal into a driving signal.

For example, after the light emitted by the light emitter 21 is transmitted or reflected by the filtering layer 31, the sub-photosensitive sensor 221 receives the light and outputs a corresponding electrical signal, and the operational amplifier 233 amplifies the electrical signal output by the photosensitive sensor 221.

For example, referring to FIG. 14, the converting circuit 232 further includes a voltage modulating circuit 234, and the voltage modulating circuit 234 is connected in series between the output terminal of the operational amplifier 233 and the display unit 231.

The voltage modulating circuit 234 is for adjusting a voltage of the driving signal to satisfy a withstand voltage value of the display unit.

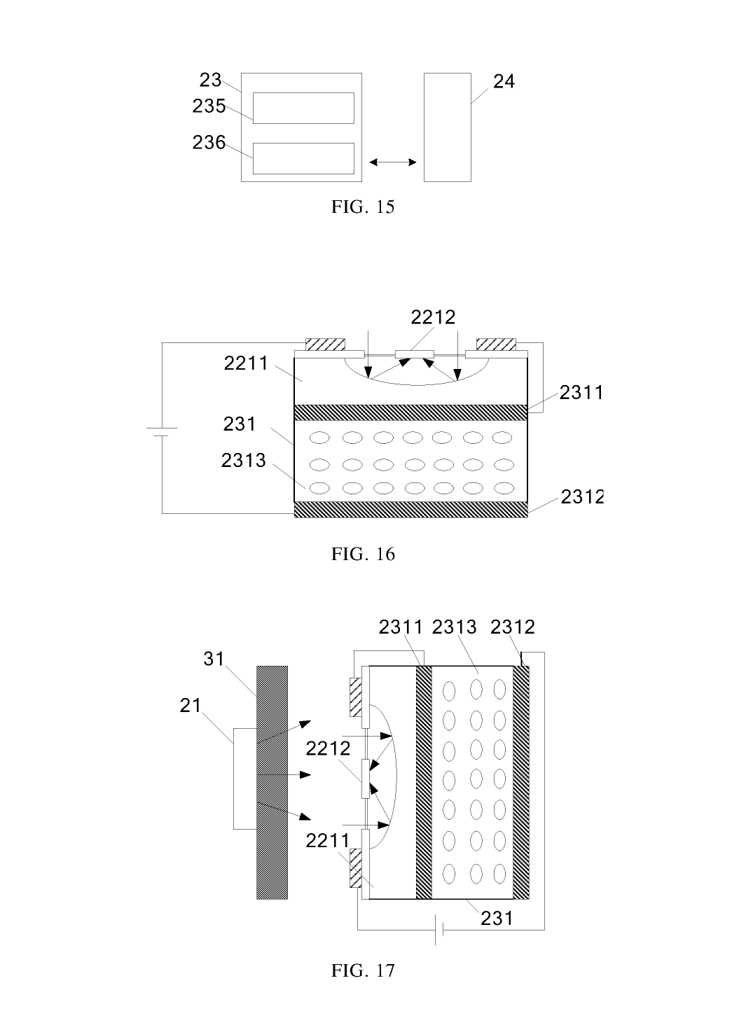

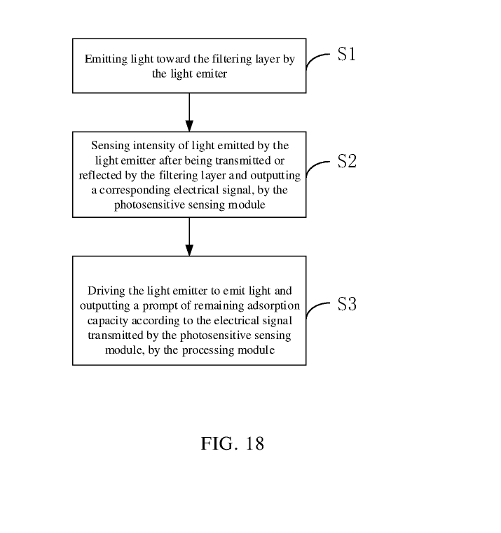

For example, referring to FIG. 15, the processing module 23 includes: a processing unit 235 and a wireless communication unit 236, and the processing unit 235 is used for generating a remaining adsorption capacity parameter of the filtering layer according to the electrical signal, wherein the electrical signal is in one-to-one correspondence with the remaining adsorption capacity parameter of the filtering layer; the wireless communication unit 236 is used for outputting the remaining adsorption capacity parameter of the filtering layer to a user device 24 in data connection therewith. For example, the processing unit 235 may be a circuit having processing capacity, or may be a processor (e.g., a central processing unit, a microprocessor, etc.), a digital signal processor (DSP), a programmable logic controller (PLC), etc.; the wireless communication unit 236 may include a modem, an antenna, etc., for example, communication may be realized in many modes such as WIFI, mobile communication network (e.g., 3G/4G/5G, etc.), Bluetooth, ZigBee and the like.

For example, the processing unit may output the remaining adsorption capacity parameter of the filtering layer according to the electrical signal transmitted by the photosensitive sensor, including: the processing unit stores a function or chart of corresponding relationship between the amount of the adsorbed substance on the filtering layer and the electrical signal output by the photosensitive sensor, and total amount of the substance which can be adsorbed by the filtering layer, the processing unit may obtain the amount of the adsorbed substance on the filtering layer by receiving the electrical signal output by the photosensitive sensor, thereby obtaining a remaining adsorption value of the filtering layer, and determining the adsorption capacity of the mask. The wireless communication unit may perform data communication with a user device, for example, a smart device such as a mobile phone or a computer and so on, and transmit real time information of the mask, including the remaining adsorption value of the filtering layer of the mask, the remaining usage time and information on whether the mask should be replaced, to the user device, so as to facilitate the user knowing the using condition of the mask in real time and replacing it when needed.

For example, the mask further comprises an indicator light disposed on an outer side of the mask; the processing module is used for receiving an instruction to turn on the indicator light output by a user device in data connection therewith, and turning on the indicator light according to the instruction. Alternatively, the processing module is used for receiving air quality information output by the user device in data connection therewith, and controlling turning on the indicator light according to the air quality information.

For example, when a user device receives real time air condition information, if a user is in smoggy weather and concentration of PM2.5 reaches a certain value, the user device may send an instruction to turn on the indicator light installed on the outer side of the mask according to the weather condition information, and the indicator light emit yellow light to ensure safe walking and playing a role of safety warning on the road. Illuminating characteristic of the yellow light may be controlled by a program to save power consumption and play a warning role, or when the user device receives the real time air condition information, the air quality information is transmitted to the processing module in the mask, and the processing module processes the air quality information and controls turning on the indicator light according to the air quality information by judging that the concentration of PM2.5 reaches a certain value.

For example, the processing module in the foregoing embodiment may be a circuit for performing data processing and transmission, and the light emitting unit may be a light emitting device such as a light emitting diode, and the user device may be a mobile phone, a navigator, a personal computer (PC), a netbook computer, a personal digital assistant (PDA), a server or the like, or the above-mentioned user device may be a PC or server provided with a software client or a software system or software application which can used the method provided by the embodiment of the present disclosure to process historical path data, and implementation environment of hardware may be in a form of a general computer, or an ASIC, or an FPGA, or a programmable extension platform such as Xtensa platform of Tensilica.

For example, referring to FIG. 6, the sub-photosensitive sensor 221 includes a micro-mirror 2211, a photosensitive material 2212; the processing module 23 includes a photonic crystal member 231, and the photonic crystal member 231 includes a first electrode 2311, a second electrode 2312, and a photonic crystal 2313 disposed between the first electrode and the second electrode.

The first electrode 2311 is connected with one terminal of the photosensitive material 2212, and the second electrode 2312 is connected with the other terminal of the photosensitive material 2212.

The micro-mirror 2211 is used for focusing light emitted by the light emitter after being transmitted or reflected by the filtering layer on the photosensitive material 2212, and the photosensitive material 2212 is used for generating an electrical signal according to intensity of the focused light, the photonic crystal 2313 is used for color changing display according to a magnitude of the electrical signal, and remaining adsorption capacity of the filtering layer is in one-to-one correspondence with the displayed color.

Light sources in respective directions are concentrated to the photosensitive material by the micro-mirror structure of the sub-photosensitive sensor, improving efficiency of receiving light, so as to improve test range and measurement accuracy.

Referring to FIG. 17, after the light emitter 21 transmits light through the filtering layer 31, the micro-mirror 2211 in the sub-photosensitive sensor focuses light sources to the photosensitive material 2212, and the photosensitive material 2212 controls a magnitude of the electrical signal according to intensity of the focused light, and the photonic crystal 2313 performs color changing display according to the magnitude of the electrical signal.

An embodiment of the present disclosure further provides a method for detecting absorption capacity of a mask, for controlling the mask described above, and referring to FIG. 8, the method comprises:

S1: emitting light toward the filtering layer by the light emitter.

S2: sensing intensity of light emitted by the light emitter after being transmitted or reflected by the filtering layer and outputting a corresponding electrical signal, by the photosensitive sensor.

S3: driving the light emitter to emit light and outputting a prompt of remaining adsorption capacity according to the electrical signal transmitted by the photosensitive sensor, by the processing module.

The light emitter emits light toward the filtering layer, the photosensitive sensor senses intensity of light emitted by the light emitter after being transmitted or reflected by the filtering layer, and outputs a corresponding electrical signal, and the processing module drives the light emitter to emit light, and outputs a prompt of remaining adsorption capacity according to the electrical signal transmitted by the photosensitive sensor, so that a change in the adsorption capacity of the mask at this time may be detected, thereby prompting a user to replace the mask in time.

What are described above is related to the specific embodiments of the disclosure only and not limitative to the scope of the disclosure. The protection scope of the disclosure shall be based on the protection scope of the claims.

1. A mask, comprising:
a mask body, the mask body including a filtering layer;
a light emitter, disposed on a side of the filtering layer, the light emitter emitting light toward the filtering layer;
a photosensitive sensor, the photosensitive sensor being configured for sensing intensity of light emitted by the light emitter after being transmitted or reflected by the filtering layer, and outputting a corresponding electrical signal,
wherein the photosensitive sensor is disposed on a side of the filtering layer where the light emitter is disposed: or, the photosensitive sensor is disposed on a side opposite to the side of the filtering layer where the light emitter is disposed.

2. The mask according to claim 1, wherein,
the light emitter includes one light emitting unit, or a light emitting array formed by at least two light emitting units; and
the photosensitive sensor includes one sub-photosensitive sensor, or a photosensitive array formed by at least two sub-photosensitive sensors.

3. The mask according to claim 1, wherein, the light emitter and the photosensitive sensor are located on a same side of the filtering layer, the light emitter and the photosensitive sensor forms an array structure;
the mask further comprises
a transflective film which is disposed between the filtering layer and the array structure formed by the light emitter and the photosensitive sensor.

4. The mask according to claim 11, wherein, the processing module includes: a display unit and a converting circuit connected between the photosensitive sensor and the display unit;
wherein, the converting circuit is configured for converting the electrical signal transmitted by the photosensitive sensor into a driving signal of the display unit, the display unit is configured for outputting a prompting signal according to the driving signal, the prompting signal being in one-to-one correspondence with the remaining adsorption capacity of the filtering layer.

5. The mask according to claim 4, wherein the converting circuit includes: an operational amplifier, two input terminals of the operational amplifier being connected with two terminals of the photosensitive sensor, and an output terminal of the operational amplifier being connected with the display unit;
the operational amplifier being configured for amplifying the electrical signal to the driving signal.

6. The mask according to claim 5, wherein, the converting circuit further includes: a voltage modulating circuit, the voltage modulating circuit being connected in series between an output terminal of the operational amplifier and the display unit;
the voltage modulating circuit being configured for adjusting a voltage of the driving signal to satisfy a withstand voltage value of the display unit.

7. The mask according to claim 11, wherein, the processing module includes: a processing unit and a wireless communication unit,
the processing unit being configured for generating a remaining adsorption capacity parameter of the filtering layer according to the electrical signal, wherein the electrical signal is in one-to-one correspondence with the remaining adsorption capacity parameter of the filtering layer;
the wireless communication unit being configured for outputting a remaining adsorption capacity parameter of the filtering layer to a user device in data connection with the wireless communication unit.

8. The mask according to claim 1, further comprising: an indicator light disposed on an outer side of the mask;
the processing module being configured for receiving an instruction for turning on the indicator light output by a user device in data connection with the processing module, and turning on the indicator light according to the instruction; or
the processing module being configured for receiving air quality information output by a user device in data connection with the processing module, and controlling turning on the indicator light according to the air quality information.

9. The mask according to claim 2, wherein, the sub-photosensitive sensor includes a micro-mirror, a photosensitive material;
the processing module includes a photonic crystal member, the photonic crystal member including a first electrode, a second electrode, and a photonic crystal disposed between the first electrode and the second electrode;
the first electrode being connected with one terminal of the photosensitive material, and the second electrode being connected with an other terminal of the photosensitive material;
the micro-mirror being configured for focusing light emitted by the light emitter after being transmitted or reflected by the filtering layer on the photosensitive material, and the photosensitive material being configured for generating the electrical signal according to intensity of the focused light, the photonic crystal being configured for color displaying according to a magnitude of the electrical signal, and the remaining adsorption capacity of the filtering layer being in one-to-one correspondence with the displayed color.

10. A method for detecting absorption capacity of a mask, for controlling the mask according to claim 1, the method comprising:
emitting light toward the filtering layer by the light emitter;
sensing intensity of light emitted by the light emitter after being transmitted or reflected by the filtering layer and outputting a corresponding electrical signal, by the photosensitive senor; sensor

11. The mask according to claim 1, further comprising:
a processing module, connected with the light emitter and the photosensitive sensor, configured for driving the light emitter to emit light, and outputting a prompt of remaining adsorption capacity according to the corresponding electrical signal transmitted by the photosensitive sensor

12. The mask according to claim 11, wherein the processing unit includes a storage, the storage stores a corresponding relationship between the corresponding electrical signal and a amount of a adsorbed substance on the filtering layer.

13. The mask according to claim 7, wherein the processing module includes a display unit connected with the processing unit and configured to display a remaining adsorption capacity parameter of the filtering layer.

14. The method for detecting absorption capacity of a mask according to claim 10, further comprising:
driving the light emitter to emit light and outputting a prompt of remaining adsorption capacity according to the corresponding electrical signal transmitted by the photosensitive sensor, by a processing module.

15. The method for detecting absorption capacity of a mask according to claim 14, wherein the processing module drives the light emitter to emit light.

16. The method for detecting absorption capacity of a mask according to claim 14, wherein the outputting a prompt of remaining adsorption capacity according to the corresponding electrical signal transmitted by the photosensitive sensor by the processing module comprises:
obtaining adsorption capacity according to a corresponding relationship between the corresponding electrical signal and an amount of a adsorbed substance on the filtering layer;
displaying a remaining adsorption capacity of the filtering layer.

17. The method for detecting absorption capacity of a mask according to claim 14, wherein the outputting a prompt of remaining adsorption capacity according to the corresponding electrical signal transmitted by the photosensitive sensor by the processing module comprises:
displaying different color according to the corresponding electrical signal transmitted by the photosensitive sensor, by a display unit.

18. The method for detecting absorption capacity of a mask according to claim 17, wherein the display unit comprises a first electrode, a second electrode, and a photonic crystal disposed between the first electrode and the second electrode, the first electrode and the second electrode are connected with two ends of the photonic crystal, and the photonic crystal is configured for displaying different colors according to a magnitude of the corresponding electrical signal.
